(19) United States
(12) Patent Application Publication
(10) Pub. No.: US 2010/0000423 A1
(43) Pub. Date: Jan. 7, 2010

(54) PEELING APPARATUS

(75) Inventors: MING-TUNG YU, TAIPEI COUNTY (TW); FU-TANG LIN, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: MING-TUNG YU, TAIPEI COUNTY (TW)

(21) Appl. No.: 12/188,656

(22) Filed: Aug. 8, 2008

(30) Foreign Application Priority Data
Jul. 2, 2008 (CN) 200820117393.4

(51) Int. Cl. A47J 17/02

(52) U.S. Cl. 99/584

(57) ABSTRACT

A peeling apparatus includes a peel body and a ceramic blade unit. The peel body has a handgrip part and two carrier arms extending from a distal end of the handgrip part. The ceramic blade unit has two opposite sides connected pivotally to the carrier arms, an inner cutting edge and an outer blunt edge extending between the opposite sides so as to expose the outer blunt edge to an exterior thereof. The inner cutting edge is used for peeling an external surface of fruit and vegetable, and the outer blunt edge is easy shoveled off waste resulted from peeling operation of the inner cutting edge.

### FIELD OF THE INVENTION

The present invention relates to a peeling apparatus, and more particularly to a peeling apparatus having a ceramic blade unit for peeling fruits and vegetables.

### BACKGROUND OF THE INVENTION

A peeling apparatus is a handy kitchen utensil in every household since its user can peel an external surface off a fruit easily. In the past, the blade unit for peeling the fruit is generally made from steel due to material limitation. The blade unit thus made is free from oxidation and contamination by the material of stainless steel, but is still liable to be contaminated with germ or beteria. Therefore there exists one drawback for the peeling apparatus since the blade is generally used for chopping and peeling edible things, and causing inconvenience to the user.

For the present days, the materials for of manufacturing ceramic blade unit are gradually improved and a ceramic engine is already available thus implementation of ceramics in the industry enters into a mature state. Because the ceramics is not liable to be contaminated, more and more kitchen utensils are made from ceramic material, such as sushi knife, vegetable knife.

During the technological development of the materials, for the blade unit of extraordinarily slim thickness but with long length, the manufacturers not skilled in the art use an auxiliary material instead of the ceramic material. However, the manufacturers have lately succeeded an invention to produce ceramic blade units for gradually replacing the conventional steel blade unit. But most manufacturers use a plastic sheath to enclose the blunt edge so as to expose the cutting edge exteriorly. Under this condition, an adjoining area between the plastic sheath and the blunt edge is easily filled with contamination, the anti-septic property of the ceramic blade unit is left only in name.

### SUMMARY OF THE INVENTION

The present invention is to provide a peeling apparatus including a ceramic blade unit having an inner cutting edge and an outer blunt edge exposed to an exterior thereof, thereby lowering the possibility of being contaminated. For those people running food centers and restaurants, the edible food is free from contamination due to utilization of the ceramic blade unit.

In accordance with the present invention, a peeling apparatus is provided to include a peel body and a ceramic blade unit.

The peel body has a handgrip part and two carrier arms extending from a distal end of the handgrip part.

The ceramic blade unit has two opposite sides connected pivotally to the carrier arms such that the blade unit is turnable relative to the carrier arms. The ceramic blade unit has an inner cutting edge and an outer blunt edge extending between the opposite sides so as to expose the outer blunt edge to an exterior thereof after assembly to the carrier arms.

The inner cutting edge is used for peeling an external surface of fruit and vegetable while the outer blunt edge is easily cleaned off the waste resulting from peeling operation of the inner cutting edge.

Furthermore, each of the carrier arms is formed with a shaft hole for receiving rotatably a respective one of the opposite sides of the ceramic blade unit and an opening in spatial communication with at least one of these shaft holes. The peeling apparatus further includes a lid mounted movably on one of the carrier arms for covering the opening, thereby preventing untimely removal of the ceramic blade unit from the carrier arms and vice versa.

The blade unit employed in the peeling apparatus of the present invention is made from ceramic material and is designed in such a manner that the outer blunt edge is not enclosed by a plastic sheath and thus expose to an exterior for easy cleaning. Moreover, the blade unit can be detached from the carrier arms when circumstance required, the edible food at food centers and restaurants are free from contamination due to utilization of the ceramic blade unit.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective front view of the first embodiment of a peeling apparatus of the present invention;

FIGS. 2 is a perspective rear view of the first embodiment of the peeling apparatus of the present invention;

FIG. 3 is a perspective front view of the second embodiment of the peeling apparatus of the present invention;

FIG. 4 is a perspective rear view of the second embodiment of the peeling apparatus of the present invention;

FIG. 5 shows how a ceramic blade unit is mounted to a peel body in the peeling apparatus of the present invention;

FIG. 6 illustrates how a modified peel body holds the ceramic blade unit in the peeling apparatus of the present invention; and

FIG. 7 illustrates how another modified peel body holds the ceramic blade unit in the peeling apparatus of the present invention.

### DETAILED DESCRIPTIONS OF THE PREFERRED EMBODIMENTS

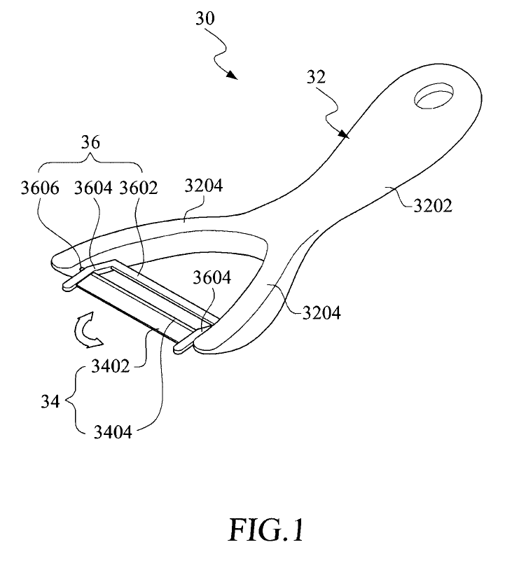

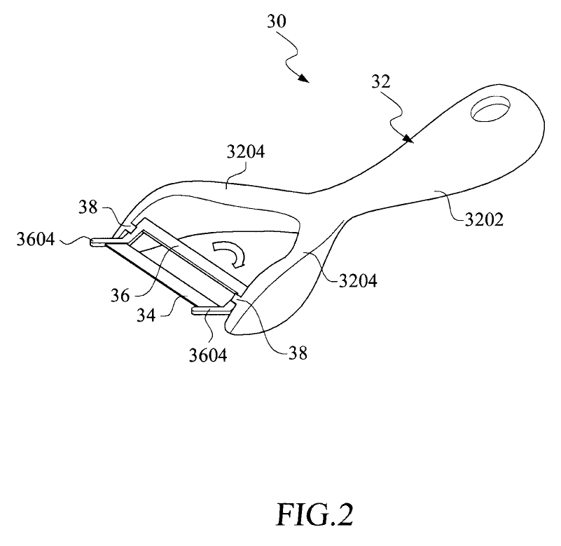

Referring to FIGS. 1 and 2, wherein FIG. 1 is a perspective front view of the first embodiment of a peeling apparatus 30 of the present invention and FIGS. 2 is a perspective rear view of the first embodiment of the peeling apparatus 30 of the present invention. The peeling apparatus 30 accordingly includes a peel body 32 and a ceramic blade unit 34.

The peel body 32 has a handgrip part 3202 and two carrier arms 3204 extending outward from a distal end of the handgrip part 3202.

The ceramic blade unit 34 has two opposite sides connected pivotally to the carrier arms 3204, an inner cutting edge 3404 and an outer blunt edge 3402 extending between the opposite sides so as to expose the outer blunt edge 3402 to an exterior thereof.

The peeling apparatus 30 further includes a blade carrier 36 for carrying the ceramic blade unit 34 thereon. To be more specific, the blade carrier 36 includes two parallel plates 3604, a transverse plate 3602 and two pivot shafts 3606.

The parallel plates 3604 are disposed adjacent to the carrier arms 3204 respectively, and securely hold the two opposite sides of the ceramic blade unit 34.

The transverse plate 3602 also interconnects the parallel plates 3604 and is spaced apart from the inner cutting edge 3404 of the ceramic blade unit 34.

The pivot shafts 3606 are mounted on the parallel plates 3604 and extend rotatably into the carrier arms 3204, thereby permitting turning of the ceramic blade unit 34 relative to the carrier arms 3204, as shown by the arrow in FIG. 1.

As illustrated in FIG. 2, the peeling apparatus 30 of the present invention further includes two stop members 38 fixed on the carrier arms 3204 respectively and extending toward for engaging with blade carrier 36 in order to prevent further rotation of the blade carrier 36 relative to the carrier arms 3204, thereby defining a turning range of the blade carrier 36.

In practical use, the inner cutting edge 3404 is used for peeling an external surface of fruit or vegetable and the outer blunt edge 3402 is easily cleaned off the waste resulting from peeling operation of the inner cutting edge 3404. Since the blunt edge 3402 is exposed to the exterior, cleaning of the same can be conducted easily.

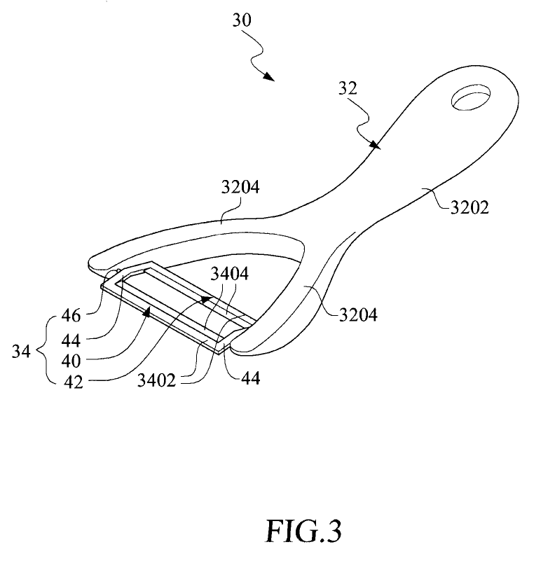

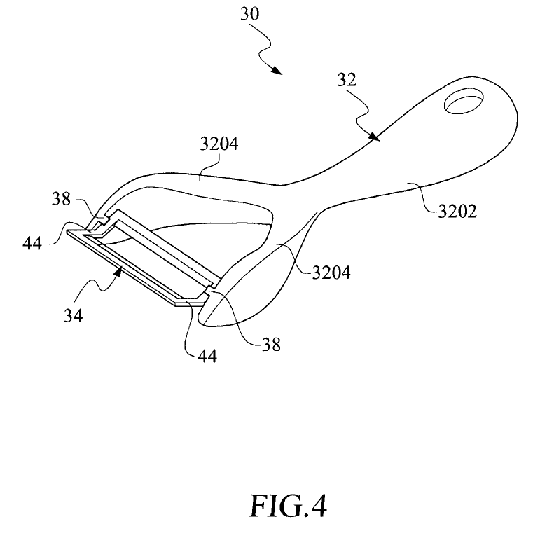

Referring to FIGS. 3 and 4, wherein FIG. 3 is a perspective front view of the second embodiment of the peeling apparatus of the present invention and FIG. 4 is a perspective rear view of the second embodiment of the peeling apparatus of the present invention. The only difference from the previous embodiment resides in that no blade carrier is implemented and the structure of the ceramic blade unit 34 is different from that employed in the previous embodiment. The ceramic blade unit 34 is a one-piece unit and includes two parallel ceramic elements 44, first and second ceramic blades 40, 42 and two ceramic shafts 46.

The parallel ceramic elements 44 are disposed adjacent to the carrier arms 3204 respectively. The first and second ceramic blades 40, 42 extend between and are connected securely to the parallel ceramic elements 44 with the outer blunt edges 3402 exposed to the exterior thereof while the inner cutting edges 3404 are spaced apart from facing each other. The ceramic shafts 46 project integrally from the parallel ceramic elements 44 to extend rotatably into the carrier arms 3204, thereby permitting turning of the ceramic blade unit 34 relative to the carrier arms 3204.

Referring to FIG. 4, the peeling apparatus 30 of the present invention further comprising two stop members 38 fixed on the carrier arms 3204 for engaging with the parallel ceramic elements 44 in order to prevent further turning of the ceramic blade unit 34 relative to the carrier arms 3204, thereby defining a turning range of the ceramic blade unit 34.

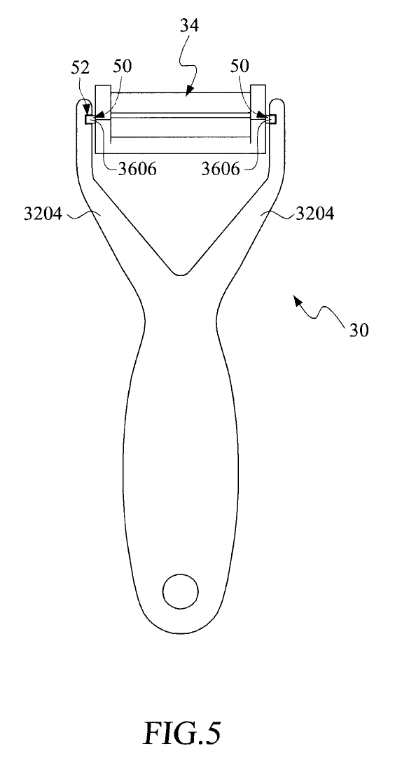

FIG. 5 shows how a ceramic blade unit is mounted to a peel body in the peeling apparatus of the present invention. As illustrated, each of the carrier arms 3204 has an inner side surface is formed with a shaft hole 50. An opening 52 is formed on the other side surface of the carrier arms 3204 and extending transverse one of the shaft holes 50. The openings 52 is in spatial communication with one of the shaft holes 50. The two pivot shafts 3606 of the blade carrier 36 extend rotatably into the shaft holes 50 in the carrier arms 3204.

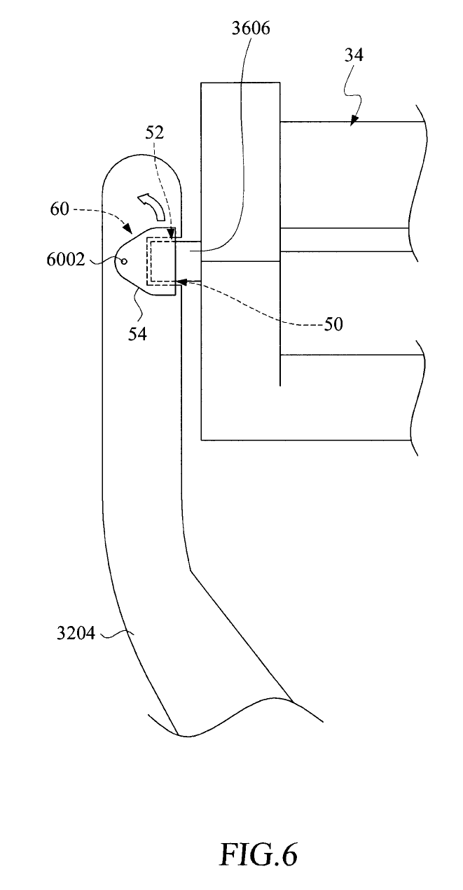

FIG. 6 illustrates how a modified peel body holds the ceramic blade unit in the peeling apparatus of the present invention. The peeling apparatus 30 of the present invention further includes a lid 54 mounted movably on one of the carrier arms 3204 for covering the opening 52, thereby preventing untimely removal of the assembly of the blade carrier 36 and the ceramic blade unit 34 from the carrier arms 3204.

Note that in the abovementioned embodiment, a coupler structure 60, such as a pin 6002 or rivet, is used for mounting the lid 54 on the carrier arm 3204 such that the lid 54 is turnable around the pin 6002 on the carrier arm 3204 (see the arrow in FIG. 6) between a first position, in which, the lid 54 covers the opening 52 to prevent removal of the blade carrier 36 hence the ceramic blade unit 34 from the carrier arms 3204 and a second position, in which, the lid 54 uncovers and thus expose the opening 52 to permit removal of the blade carrier 36 from the carrier arms.

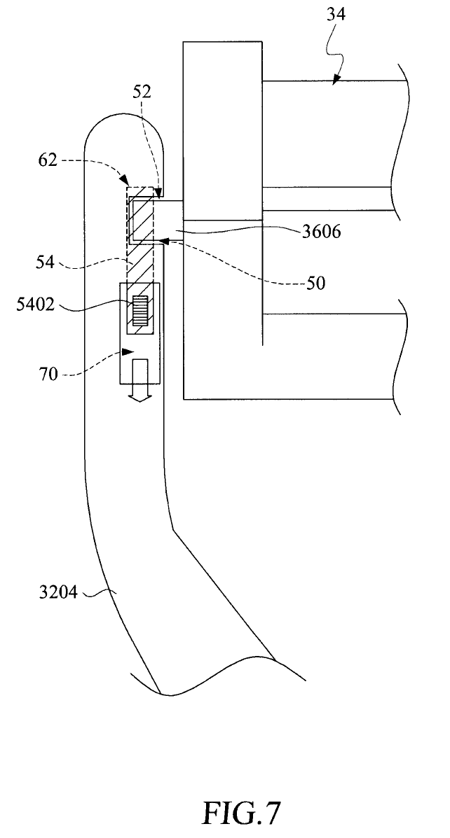

FIG. 7 illustrates how another modified peel body holds the ceramic blade unit in the peeling apparatus of the present invention. The only difference with the previous embodiment resides in that one of the carrier arms 3204 is further formed a guide track 62 extending across the opening 52. The lid 54 is disposed slidably on the guide track 62 for covering the opening 52. The lid 54 is provided with a locking knob 5402 that engages the track 62 in the normal condition and prevents movement of the lid 54 on the track 62. When it is desired to remove the assembly of the blade carrier 36 and the ceramic blade unit 34, the locking knob 5402 is pressed downward relative to the carrier arm 3204 so as to slide the lid 54 along the guide track 62 between the first and second positions as explained above, thereby preventing untimely removal of the assembly of the blade carrier 36 and the ceramic blade unit 34 from the carrier arms 3204 and vice versa.

In the abovementioned two embodiments, since the ceramic blade unit 34 is replaced whenever it is required, the ceramic blade unit 34 is always free from contamination in addition to the facts that the ceramic blade unit 34 itself is difficult to adhere with beteria. Moreover, since the inner and outer edges are easy to wash, the hygiene of the peeling apparatus of the present invention is enhanced.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A peeling apparatus comprising:
a peel body having a handgrip part and two carrier arms extending from a distal end of said handgrip part;
a ceramic blade unit having two opposite sides connected pivotally to said carrier arms, an inner cutting edge and an outer blunt edge extending between said opposite sides so as to expose said outer blunt edge to an exterior thereof; and
wherein, said inner cutting edge is used for peeling an external surface of fruit and vegetable and said outer blunt edge exposed is easy to be washed.

2. The peeling apparatus according to claim 1, further comprising a blade carrier for carrying said ceramic blade unit thereon, said blade carrier including
two parallel plates disposed adjacent to said carrier arms respectively, and securely holding said two opposite sides of said ceramic blade unit;
a transverse plate interconnecting said parallel plates and spaced apart from said inner cutting edge; and
two pivot shafts mounted on said parallel plates and extending rotatably into said carrier arms, thereby permitting turning of assembly of said blade carrier and said ceramic blade unit relative to said carrier arms.

3. The peeling apparatus according to claim 1, further comprising a stop member for engaging with said blade carrier in order to prevent further rotation of said blade carrier relative to said carrier arms, thereby defining a turning range of said blade carrier.

4. The peeling apparatus according to claim 1, wherein said ceramic blade unit includes:
two parallel ceramic elements disposed adjacent to said carrier arms respectively;
first and second ceramic blades extending between and connected securely to said parallel ceramic elements with said outer blunt edges exposed to said exterior thereof while said inner cutting edges are spaced apart from and facing each other; and
two ceramic shafts projecting integrally from said parallel ceramic elements to extend rotatably into said carrier arms, thereby permitting turning of said ceramic blade unit relative to said carrier arms.

5. The peeling apparatus according to claim 4, further comprising two stop members fixed on said carrier arms for engaging with said parallel ceramic elements in order to prevent further turning of said ceramic blade unit relative to said carrier arms, thereby defining a turning range of said ceramic blade unit.

6. The peeling apparatus according to claim 1, wherein each of said carrier arms is formed with a shaft hole for receiving rotatably a respective one of said opposite sides of said ceramic blade unit and an opening in spatial communication with one of the shaft holes, the peeling apparatus further comprising a lid mounted movably on one of said carrier arms for covering said opening, thereby preventing untimely removal of said ceramic blade unit from said carrier arms.

7. The peeling apparatus according to claim 6, further comprising a coupler structure for mounting said lid on said carrier arm such that said lid is movable on said carrier arm between a first position, in which, said lid covers said opening to prevent removal of said ceramic blade unit from said carrier arms and a second position, in which, said lid uncovers and thus expose said opening to permit removal of said ceramic blade unit from said carrier arms.

8. The peeling apparatus according to claim 6, wherein each of said carrier arms is further formed a guide track extending across said opening, said lid being disposed slidably on said guide track for covering said opening.
